(19) United States
(12) Patent Application Publication
(10) Pub. No.: US 2026/0238627 A1
(43) Pub. Date: Aug. 13, 2026

(54) DATA PROCESSING METHOD AND DEVICE, STORAGE MEDIUM, AND PROGRAM PRODUCT

(71) Applicant: Tencent Technology (Shenzhen) Company Limited, Shenzhen (CN)

(72) Inventors: Jun FENG, Shenzhen (CN); Jiawei Xu, Shenzhen, Guangdong (CN); Wenpeng Zeng, Shenzhen (CN); Zemin Lin, Shenzhen (CN)

(73) Assignee: Tencent Technology (Shenzhen) Company Limited, Shenzhen (CN)

(21) Appl. No.: 19/637,534

(22) Filed: Apr. 2, 2026

Related U.S. Application Data
(63) Continuation of application No. PCT/CN2025/082803, filed on Mar. 17, 2025.

(30) Foreign Application Priority Data
Mar. 25, 2024 (CN) 202410354430.7

(51) Int. Cl. H04L 9/40

(52) U.S. Cl. CPC H04L 63/08

(57) ABSTRACT

A method, device, and computer-readable storage medium for an improved data processing method on an access device is provided. The method receives an access request transmitted by a terminal device. The access request includes first data and a user identifier, and the user identifier has a mapping relationship with configuration information. The configuration information is configured to indicate whether different types of data are allowed to be transmitted to a target server. The access request is forwarded to a data authentication server after detecting that the access request has a corresponding data authentication rule, so that the data authentication server performs authentication processing on the first data based on the configuration information to obtain an authentication result. Interception processing or transmission processing is performed on the first data after receiving the authentication result transmitted by the data authentication server.

### CROSS REFERENCE TO RELATED APPLICATION

This application is a bypass continuation application of International Patent Application No. PCT/CN2025/082803, filed on March 17, 2025, which claims priority to and is based on Chinese Patent Application No. 202410354430.7, filed on March 25, 2024, the disclosures of which are incorporated herein in their entireties by reference.

### FIELD

Embodiments of the present disclosure relate to the field of computer technologies, and in particular, to data processing.

### BACKGROUND

A cloud-based acceleration channel is a cloud service provided by a cloud platform, and may be understood as an acceleration channel established between a client and a server. The cloud-based acceleration channel relies on a high-speed channel between own global nodes of the cloud platform, a forwarding cluster, and an intelligent routing technology, to enable users in different locations to access at the nearest point. Reaching a source station area through the high-speed channel helps services resolve issues of slow access or excessively high latency for global users. Based on these advantages of the cloud-based acceleration channel, this solution will be selected during deployment of many services (especially globally-served games or service systems of multinational enterprises). In recent years, with attention paid to security protection of data prone to leakage such as user personal information or other user-defined data, services utilizing the cloud-based acceleration channel urgently need a convenient, flexible, and accurate data interception function to ensure that the data is securely and legally collected, transmitted, and used.

In a conventional data interception manner, generally, a software development kit (SDK) used for implementing the data interception function is integrated in the client, and further processing data using the SDK, so as to intercept data that is not allowed to be transmitted to the server or not intercept data that is allowed to be transmitted to the server. However, the data is currently intercepted in a manner of reforming and upgrading the client (i.e., integrating the SDK in the client). Generally, the client cannot be upgraded and reformed due to increased difficulty and costs of reforming and upgrading, resulting in a poor data interception effect, and further failing to ensure data security.

### SUMMARY

Provided are a data processing method and device, and a computer-readable storage medium, which may decide to intercept first data in advance or continue transmitting the first data at an access device based on an authentication result fed back by a data authentication server, without upgrading and reforming a client. This not only reduces costs and difficulty of upgrading and reforming, but also can improve an effect of data interception.

According to an aspect of some embodiments of the present disclosure, a data processing method may be applied to an access device. The method includes: receiving an access request transmitted by a terminal device, the access request including first data and a user identifier, the user identifier having a mapping relationship with configuration information, and the configuration information being configured to indicate whether different types of data are allowed to be transmitted to a target server; forwarding the access request to the data authentication server after detecting that the access request has a corresponding data authentication rule, so that the data authentication server, after finding the configuration information based on the user identifier and the mapping relationship, performs authentication processing on the first data based on the configuration information to obtain an authentication result; and performing, based on the authentication result, interception processing or transmission processing on the first data after receiving the authentication result transmitted by the data authentication server.

According to an aspect of some embodiments of the present disclosure, a data processing method may be applied to a data authentication server. The method includes: receiving an access request transmitted by an access device, the access request including first data and a user identifier, the user identifier having a mapping relationship with configuration information, and the configuration information being configured for indicating whether different types of data are allowed to be transmitted to a target server; searching for the configuration information based on the user identifier in the access request and the mapping relationship; and performing authentication processing on the first data based on the configuration information to obtain an authentication result; and transmitting the authentication result to the access device, the authentication result being configured for the access device to perform interception processing or transmission processing on the first data. The method includes performing interception processing on the first data based on a first status code when the authentication result comprises the first status code, so as to not transmit the first data to the target server, the first status code being configured for representing a response code when the first data needs to be intercepted, and the first status code is a response code 401. The method includes transmitting the first response information to the terminal device, the first response information being configured for the terminal device for learning that the access request has been responded. The method includes transmitting the first data to the target server based on a second status code through a cloud-based acceleration channel when the authentication result comprises the second status code, the second status code being configured for representing a response code when the first data does not need to be intercepted, and the second status code is a response code 200. The method includes, after the transmitting the first data to the target server based on a second status code through a cloud-based acceleration channel, receiving an access response message transmitted by the target server, the access response message comprising second data, and the second data being data obtained by the target server in response to the first data; and forwarding the access response message to the terminal device. The method includes, after the detecting that the access request has a corresponding data authentication rule, obtaining second response information, the second response information being configured for indicating a response situation when access to the data authentication server fails for the access request; and transmitting the second response information to the terminal device, the second response information being configured for instructing the terminal device to retransmit the access request.

According to an aspect of some embodiments of the present disclosure, an access device includes at least one memory configured to store program code; and at least one processor configured to read the program code and operate as instructed by the program code, the program code including: a first receiving code configured to cause the at least one of the at least one processor to receive an access request transmitted by a terminal device, the access request comprising first data and a user identifier, the user identifier having a mapping relationship with configuration information, and the configuration information being configured for indicating whether different types of data are allowed to be transmitted to a target server; a first transmitting code configured to cause the at least one of the at least one processor to forward the access request to a data authentication server after detecting that the access request has a corresponding data authentication rule, so that the data authentication server, after finding the configuration information based on the user identifier and the mapping relationship, performs authentication processing on the first data based on the configuration information to obtain an authentication result; and a processing code configured to cause the at least one of the at least one processor to perform, based on the authentication result, interception processing or transmission processing on the first data after receiving the authentication result transmitted by the data authentication server

According to an aspect of some embodiments of the present disclosure, a data authentication server includes a receiving module, a processing module, and a transmitting module. The receiving module is configured to receive an access request transmitted by an access device, the access request including first data and a user identifier, the user identifier having a mapping relationship with configuration information, and the configuration information being configured for indicating whether different types of data are allowed to be transmitted to the target server. The processing module is configured to search for the configuration information based on the user identifier in the access request and the mapping relationship. The processing module is configured to perform authentication processing on the first data based on the configuration information to obtain an authentication result. The transmitting module is configured to transmit the authentication result to the access device, the authentication result being configured for the access device to perform interception processing or transmission processing on the first data.

According to an aspect of some embodiments of the present disclosure, a non-transitory computer-readable storage medium, storing computer code which, when executed by at least one processor, causes the at least one processor to at least: receive an access request transmitted by a terminal device, the access request comprising first data and a user identifier, the user identifier having a mapping relationship with configuration information, and the configuration information being configured to indicate whether different types of data are allowed to be transmitted to a target server; forward the access request to a data authentication server after detecting that the access request has a corresponding data authentication rule, so that the data authentication server, after finding the configuration information based on the user identifier and the mapping relationship, performs authentication processing on the first data based on the configuration information to obtain an authentication result; and perform, based on the authentication result, interception processing or transmission processing on the first data after receiving the authentication result transmitted by the data authentication server.

As can be seen from the foregoing technical solutions that the embodiments of the present disclosure have the following advantages:

In the embodiments of the present disclosure, the access request transmitted by the terminal device is received by the access device. The access request includes the first data and the user identifier, and there is a mapping relationship between the user identifier and the configuration information. The mentioned configuration information can be configured for indicating whether the different types of data are allowed to be transmitted to the target server. Then, the access device forwards the access request to the data authentication server after detecting that the access request has the corresponding data authentication rule, so that the data authentication server, after finding the configuration information based on the user identifier and the mapping relationship, performs the authentication processing on the first data based on the configuration information to obtain the authentication result. In this way, the access device then performs, based on the authentication result again, the interception processing or the transmission processing on the first data after receiving the authentication result transmitted by the data authentication server. In the foregoing manner, in the present disclosure, before the access request, the first data, and the like that are transmitted by the terminal device are transmitted to the target server, the access device first forwards the access request to the data authentication server, and further decides, in advance using the authentication result fed back by the data authentication server after the data authentication server performs the authentication processing on the first data, whether to intercept this first data or continue to transmit the first data. In other words, in the present disclosure, by adding the data authentication server, a data interception function is then implemented by the access device and the data authentication server. Before the first data is transmitted to the target server, whether to intercept the first data can be decided in advance at the access device based on the authentication result fed back by the data authentication server, without upgrading and reforming the terminal device or the target server. This not only reduces costs and difficulty of upgrading and reforming, but also can improve an effect of data interception.

The above general descriptions and the following detailed descriptions are merely for exemplary and explanatory purposes, and cannot limit the present disclosure. Details of one or more embodiments of the present disclosure are set forth in the accompanying drawings and descriptions below. Other features and advantages of the present disclosure will be apparent from the specification, accompanying drawings, and claims

### BRIEF DESCRIPTION OF DRAWINGS

To describe the technical solutions in the embodiments of the present disclosure more clearly, the following briefly describes the accompanying drawings required for describing the embodiments of the present disclosure. The accompanying drawings in the following description show only some embodiments of the present disclosure, and a person of ordinary skill in the art may still derive other drawings from these accompanying drawings without creative efforts. In addition, one of ordinary skill would understand that aspects of some embodiments may be combined together or implemented alone.

FIG. 1 shows a schematic diagram of data transmission through an acceleration channel in a related solution.

FIG. 2 shows a schematic diagram of a system architecture of data processing according to an embodiment of the present disclosure.

FIG. 3 shows a flowchart of a data processing method according to an embodiment of the present disclosure.

FIG. 4 shows an exemplary schematic diagram of first data according to the present disclosure.

FIG. 5 shows an exemplary schematic diagram of a data authentication rule according to the present disclosure.

FIG. 6 shows an exemplary schematic diagram when data needs to be intercepted according to the present disclosure.

FIG. 7 shows another exemplary schematic flowchart of data processing according to the present disclosure.

FIG. 8 shows another exemplary schematic flowchart of data processing according to the present disclosure.

FIG. 9 shows an exemplary schematic diagram of functional modules of an access device according to an embodiment of the present disclosure.

FIG. 10 shows an exemplary schematic diagram of functional modules of a data authentication server according to an embodiment of the present disclosure.

FIG. 11 shows an exemplary schematic diagram of a hardware structure of a data processing device according to an embodiment of the present disclosure.

### DETAILED DESCRIPTION

Embodiments of the present disclosure provide a data processing method and device, a storage medium, which may decide to intercept first data in advance or continue transmitting the first data at an access device based on an authentication result fed back by a data authentication server, without upgrading and reforming a client. This not only reduces costs and difficulty of upgrading and reforming, but also can improve an effect of data interception.

In implementations of the present disclosure, relevant data such as user information is involved. When the foregoing embodiments of the present disclosure are applied to a specific product or technology, a permission or consent of a user is required, and collection, using, and processing of the related data need to comply with relevant laws, regulations, and standards of relevant countries and regions.

The technical solutions in the embodiments of the present disclosure are clearly and completely described in the following with reference to the accompanying drawings in the embodiments of the present disclosure. Apparently, the described embodiments are merely some rather than all of the embodiments of the present disclosure. All other embodiments obtained by a person of ordinary skills in the art based on the embodiments of the present disclosure without creative efforts are to fall within the protection scope of the present disclosure.

The terms such as “first”, “second”, “third”, and “fourth” (if any) in the specification and claims of the present disclosure and in the accompanying drawings are used to distinguish similar objects and not necessarily used for describing any particular order or sequence. Data used in this way is exchangeable in a proper case, so that the embodiments of the present disclosure described herein, for example, can be implemented in sequences except those illustrated or described herein. Moreover, the terms “include”, “contain” and any other variants mean to cover the non-exclusive inclusion, for example, a process, method, system, product, or device that includes a list of steps or units is not necessarily limited to those expressly listed steps or units, but may include other steps or units not expressly listed or inherent to such a process, method, system, product, or device.

To transmit data from a terminal device to a server or from a server to a terminal device, a transmission channel needs to be established between the terminal device and the server in advance. Data can be transmitted between the terminal device and the server only after the transmission channel is established. In some transmission scenarios, to accelerate transmission efficiency and enable users in different locations to access at the nearest point, there has been a shift towards utilizing a cloud-based acceleration channel between the terminal device and the server for implementation.

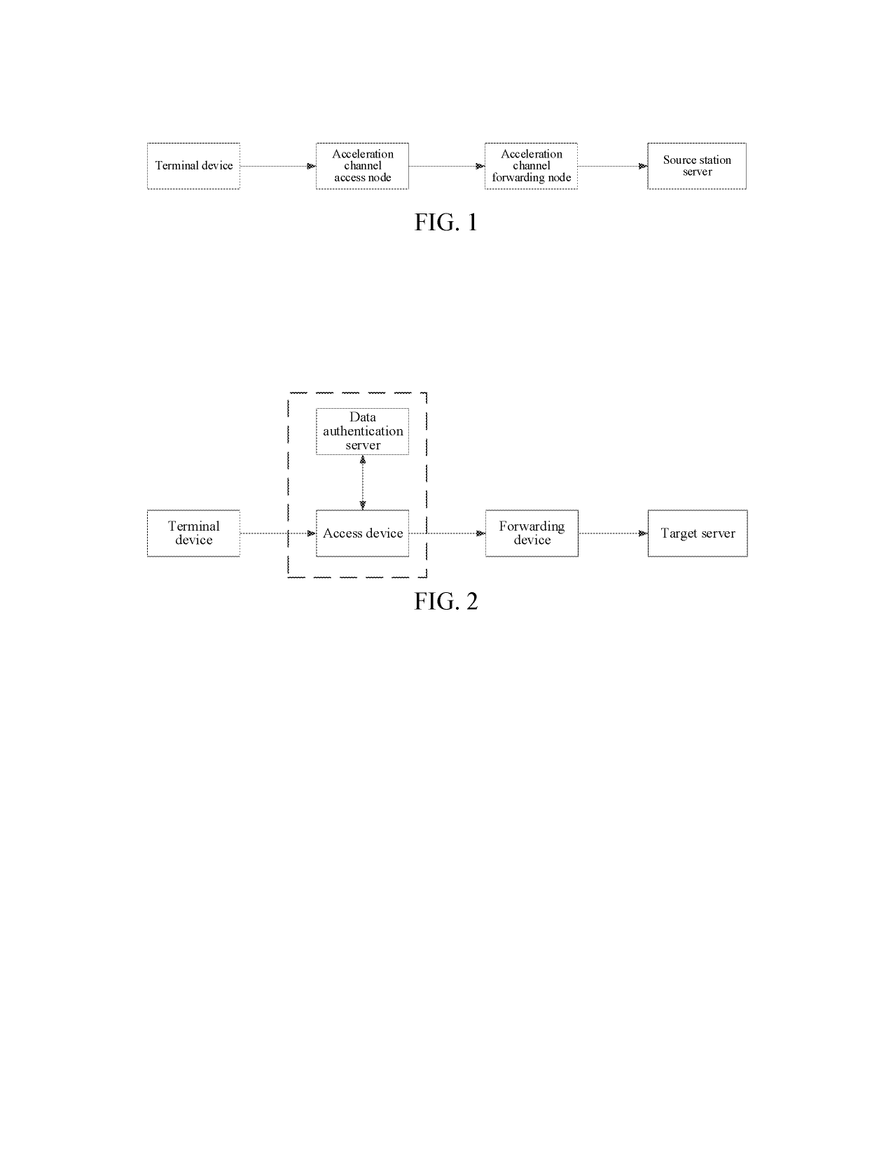

The described cloud-based acceleration channel may be understood as an acceleration channel established between the terminal device and the server using a cloud platform. Using the cloud-based acceleration channel, data transmission between the terminal device and the server may be rapidly implemented. FIG. 1 shows a schematic diagram of data transmission through an acceleration channel in a related solution. As shown in FIG. 1, an example in which the client is a terminal device is used. In a process in which the terminal device needs to transmit data to a source station server, the terminal device first transmits the data to an acceleration channel access node, and then forwards the data to an acceleration channel forwarding node using the acceleration channel access node. Finally, the acceleration channel forwarding node forwards the data to the source station server, and the source station server receives the data transmitted by the terminal device.

In the foregoing data transmission process, a target object expects that some data that needs to be protected and that is prone to leakage or some user-defined data does not need to be transmitted to the server. In this case, interception processing may be performed on these data on a transmission link shown in FIG. 1, to avoid transmission of related data to the server. However, in a conventional data interception solution, whether data is to be intercepted needs to be verified by relying on an SDK in the terminal device such as the client. However, due to significant difficulty and costs of reforming and upgrading, such an interception manner is easy to cause situations where the data that is prone to leakage or the user-defined data that does not need to be transmitted is easily transmitted to the server during data inspection with the current SDK. This causes ineffective data interception, thereby failing to ensure data security. Also, the terminal device such as the client needs to be reformed and upgraded to complete the data interception, resulting in increased difficulty and costs of reforming and upgrading.

Therefore, to resolve the technical problem mentioned above, an embodiment of the present disclosure provides a data processing method. The data processing method may be applied to a system architecture shown in FIG. 2. As shown in FIG. 2, the system architecture at least includes a terminal device, an access device, a data authentication server, a forwarding device, and a target server. The terminal device sequentially establishes a communication connection with the target server using the access device and the forwarding device. In addition, the access device further establishes a communication connection with the data authentication server, to implement a data interception function using the access device and the data authentication server.

In the present disclosure, before the target object transmits data to the target server using the terminal device, configuration information may be set in advance using the terminal device, to identify which types of data may be transmitted to the target server, and which types of data are not expected to be transmitted to the target server. Therefore, a mapping relationship between a user identifier and the configuration information of the data is constructed. The mentioned user identifier may be used to identify the target object. The mentioned configuration information can represent a configuration situation regarding whether different types of data (for example, first data mentioned below) are allowed to be transmitted to the target server for the target object corresponding to the user identifier. The first data mentioned in the present disclosure may be understood as any data transmitted from the terminal device to the target server.

In this way, after the setting of the mapping relationship between the configuration information of the data and the user identifier is completed, the target object may transmit an access request to the target server using the terminal device. The access request includes the first data and the user identifier. Because the terminal device needs to access the target server using the access device, the access request is received by the access device before being obtained by the target server.

After receiving the access request, the access device does not directly transmit the access request to the target server using the forwarding device, but detects whether the access request has a corresponding data authentication rule firstly. After detecting the data authentication rule, the access device forwards the access request to the data authentication server. Therefore, the data authentication server searches for the configuration information based on the user identifier and the mapping relationship, and after finding the configuration information, performs authentication processing on the first data based on the configuration information, so as to determine an authentication result. In this way, the data authentication server then transmits the authentication result to the access device.

After receiving the authentication result transmitted by the data authentication server, the access device performs interception processing on the first data or transmits the first data to the target server using the forwarding device based on the authentication result. That is, in the present disclosure, a data interception function is implemented by newly adding the data authentication server, and using the access device and the data authentication server. Before the first data is transmitted to the target server, whether to intercept the first data can be determined in advance at the access device based on the authentication result fed back by the data authentication server, without upgrading and reforming the terminal device. This not only avoids data leakage and improves data security, but also reduces difficulty and costs of upgrading and reforming.

The access device mentioned in FIG. 2 may include but is not limited to the foregoing acceleration channel access node shown in FIG. 1 or another access apparatus having an acceleration function. This is not limited in the present disclosure. In addition, the forwarding device shown in FIG. 2 may include, but is not limited to, the acceleration channel forwarding node shown in FIG. 1 or another forwarding apparatus having an acceleration function. This is not limited in the present disclosure. The target server shown in FIG. 2 may include, but is not limited to, the foregoing source station server shown in FIG. 1 or another service server. This is not limited in the present disclosure. In addition, the data authentication server mentioned in FIG. 2 may be understood as a server having a data authentication function, another device, or the like. This is not limited in the present disclosure. In some embodiments, the data authentication server mentioned in the present disclosure may also be an apparatus having the data authentication function or the like in the access device during actual application. In the embodiment of the present disclosure, only an example in which the data authentication server is used as an authentication device independent of the access device is used for description, and a manner in which the data authentication server exists is not specifically limited.

The data processing method provided in the embodiment of the present disclosure may be implemented using a computer device. The computer device may be a terminal device or a server, where the server may be an independent physical server, or may be a server cluster composed of a plurality of physical servers or a distributed system, or may be a cloud server that provides basic cloud computing services such as cloud computing, a cloud database, cloud computing, a cloud function, cloud storage, a network service, cloud communication, a middleware service, a domain name service, a security service, a content delivery network (CDN), and a big data and artificial intelligence platform. The terminal device includes, but is not limited to, a mobile phone, a computer, an intelligent voice interaction device, an intelligent household appliance, an in-vehicle terminal, and an aircraft. The terminal device and the server may be connected directly or indirectly in a wired communication manner or a wireless communication manner. This is not limited in the present disclosure.

Some embodiments are performed by a computer device used as an access device, and some embodiments are performed by a computer device used as a data authentication server.

For example, the data processing method provided in the embodiment of the present disclosure may further be applied to various scenarios such as artificial intelligence, a cloud technology, intelligent Internet of Things, Internet of Vehicles, and a virtual game. This is not limited in the present disclosure.

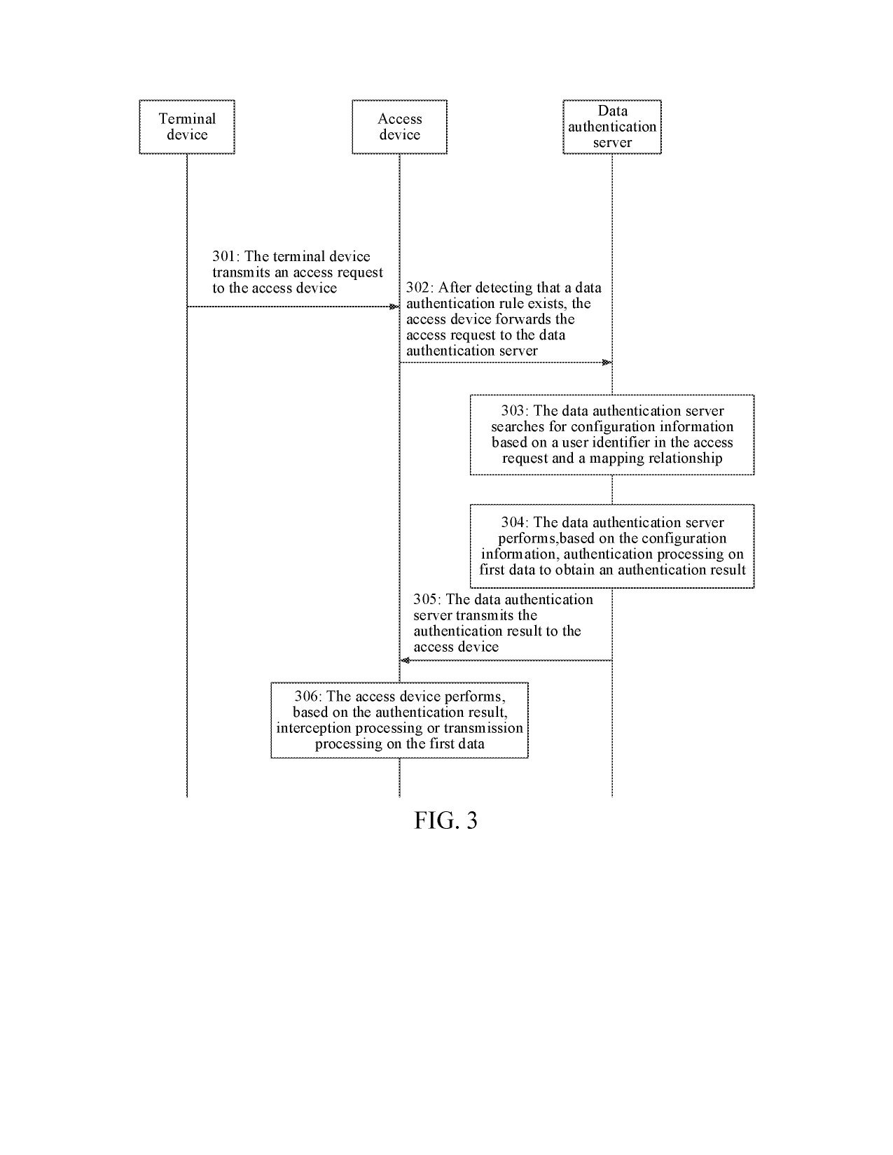

A data processing method provided in an embodiment of the present disclosure is described below with reference to the accompanying drawings. FIG. 3 shows a flowchart of a data processing method according to an embodiment of the present disclosure. The method may be performed by an access device. As shown in FIG. 3, the data processing method may include the following operations.

301: A terminal device transmits an access request to an access device, the access request including first data and a user identifier, the user identifier having a mapping relationship with configuration information, and the configuration information being configured to indicate whether different types of data are allowed to be transmitted to a target server.

In this example, before a target object transmits data to the target server using the terminal device, the configuration information may be set in advance by using the terminal device. The configuration information identifies which types of data may be transmitted to the target server in a transmission process, and which types of data are not expected to be transmitted to the target server. Therefore, a mapping relationship between the user identifier and the configuration information may be constructed. In other words, in the present disclosure, the target object sets different configuration information for different types of data in advance using the terminal device, to indicate, using the configuration information, a configuration situation regarding whether each type of data is allowed to be transmitted to the target server for the target object corresponding to the user identifier.

To accurately identify which types of data may be transmitted to the target server and which types of data may not be transmitted to the target server, the described configuration information includes a configuration status. The configuration status can reflect an indication that is set when the target object sets whether to allow transmission of a certain type of data to the target server. For example, the configuration status includes at least one of a first setting status or a second setting status. The mentioned first setting status may be understood as that the target object is not allowed to transmit a certain type of data to the target server. In an exemplary description, for data information, some types of data expected by the target object such as a developer are stored in a local database, and some types of data are allowed to be uploaded to the server for storage. Based on this, the target object separately sets different configuration statuses in the configuration information for different types of data.

For example, for personal information, other types of data that are prone to leakage or have a relatively high security level, and the like, the target object stores them in the local database. Therefore, for this type of data, the target object may set the corresponding configuration status to the first setting status using the terminal device.

On the contrary, the mentioned second setting status is understood as that the target object allows to transmit a certain type of data to the target server. For example, for some types of data such as files, pictures, audios, and other data with a relatively low security level that do not relate to security, the target object does not pay much attention to the security of these types of data, and allows them to be transmitted to the target server. Therefore, for this type of data, the target object may set, using the terminal device, the corresponding configuration status to the second setting status.

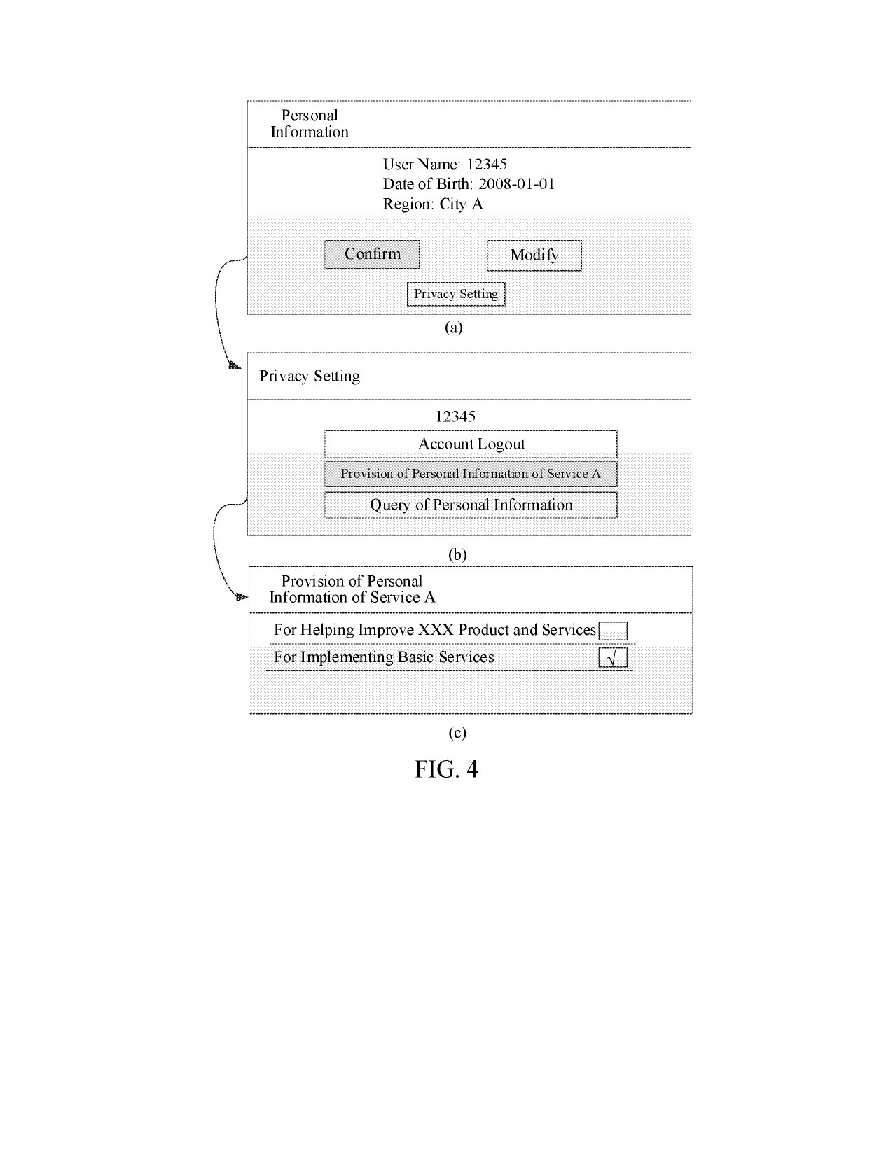

For example, FIG. 4 shows an exemplary schematic diagram of first data according to the present disclosure. As shown in FIG. 4, an example in which a service (for example, Service A) and “Personal Information of Service A” are used as the first data is used. For a target object whose user name is “12345”, the target object does not transmit the “Personal Information of Service A” to the server, so as to help improve a XXX product and services. As can be seen from sections (a) to (c) in FIG. 4, the target object may find an option about “Personal Information of Service A” from a setting of “Personal Information-> Privacy Setting -> Provision of Personal Information of Service A”, for example, “For Helping Improve XXX Product and Services”. After the option of the first data is queried, the target object may perform status setting for the “Personal Information of Service A”, for example, set to the first setting status. For example, as shown in section (c) in FIG. 4, for the “Personal Information of Service A”, the target object may “not check” a corresponding setting option to set the configuration status corresponding to the “Personal Information of Service A” to the first setting status.

In this way, after the target object sets different setting statuses for different types of data according to own service requirements using the terminal device, the terminal device may generate the configuration information corresponding to each type of data. Further, the terminal device may further map the configuration information and the user identifier, to determine the mapping relationship between the user identifier and the configuration information, so that subsequently, after learning the user identifier carried in the access request, the data authentication server may rapidly find the corresponding configuration information using the mapping relationship, and further determine, through authentication, whether the first data needs to be transmitted to the target server.

In this way, after generating the access request based on the service requirements of the target object, the terminal device transmits the access request to the target server. Because the access device is located in a data connection link between the terminal device and the target server, the access device first receives the access request. For example, the access request may be transmitted to the target server through a cloud-based acceleration channel.

302: After detecting that the access request has a corresponding data authentication rule, the access device forwards the access request to a data authentication server.

In this example, service operation and maintenance personnel and the like may further configure information such as an access protocol, a data authentication result field, and a response field using the access device in advance based on the service requirements, so that after obtaining the information such as the access protocol, the data authentication result field, and the response field, the access device generates the data authentication rule based on the information such as the access protocol, the data authentication result field, and the response field.

Based on an authentication requirement on the data in the access request, a correspondence may be established between the data authentication rule and the access request for which data authentication needs to be performed, and which data in the access request needing to be authenticated is determined based on the correspondence. For example, for some types of access requests, some data carried in these access requests may not be transmitted to the target server, and then a correspondence may be established between these types of access requests and the data authentication rule. For some types of access requests, data carried in these access requests may not be transmitted to the target server, and then a correspondence between these types of access requests and the data authentication rule may not be established.

The described access protocol may include, but is not limited to, hypertext transfer protocol (HTTP). This is not limited in the present disclosure. In an exemplary description, in the present disclosure, only an example in which the HTTP is used as an access protocol is used. The HTTP may include information such as a request header, a request body, and a request uniform resource locator (URL).

The data authentication result field may include a field needing to be intercepted or a field not needing to be intercepted. A corresponding first status code may be correspondingly set for the data authentication result field needing to be intercepted. For example, using the HTTP as an example, in this case, the first status code may be a response code 401 in the HTTP. A corresponding second status code may be correspondingly set for the data authentication result field not needing to be intercepted. For example, using the HTTP as an example, in this case, the second status code may be a response code 200 in the HTTP.

In addition, the described response field may include response fields in two cases, for example, a response field fed back to the terminal device when the response field needs to be intercepted, and a response field fed back to the terminal device when access to the data authentication server fails. For example, corresponding first response information may be configured for the response field fed back to the terminal device when the response field needs to be intercepted. The first response information includes a response header, a response body, and a response code. Alternatively, corresponding second response information may be configured for the response field fed back to the terminal device when the access to the data authentication server fails. The second response information includes a response header, a response body, and a response code. A difference between the first response information and the second response information lies in that: the first response information is configured to notify the terminal device that the access request has been responded, so that the terminal device does not need to perceive that the access request has been intercepted; and the second response information is configured to notify the terminal device that the access request fails to be accessed by the data authentication server, and the access request needs to be retransmitted.

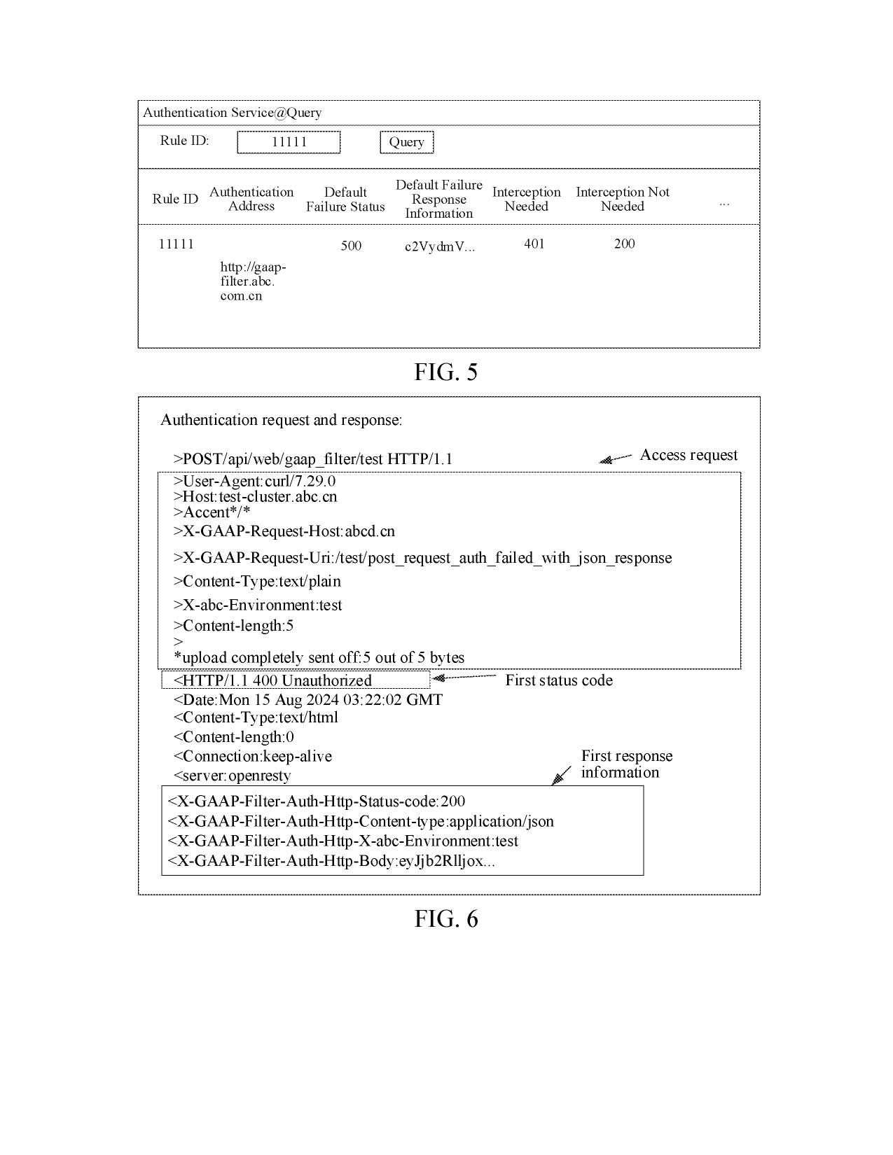

For example, FIG. 5 shows an exemplary schematic diagram of a data authentication rule according to the present disclosure. As shown in FIG. 5, in the data authentication rule corresponding to a rule identity (ID) “11111”, an authentication address is set to “http://gaap-filter.abc.com.cn”, a response code corresponding to a default failure status is 500, and default failure response information corresponding to the data authentication rule is “c2VydmV...”. In addition, in the data authentication rule, a first status code when interception is needed is the response code 401, a second status code when the interception is not needed is the response code 200, and so on.

A situation, such as a forwarding rule, for the access request can be learned using the data authentication rule. For example, the access device may further store the data authentication rule.

After detecting that the access request has the corresponding data authentication rule, the access device may transmit the access request to the data authentication server.

That is, whether the data (for example, the first data) carried in the access request has a possibility of interception authentication is accurately identified according to whether the access request has the corresponding data authentication rule. When the access request has the corresponding data authentication rule, the access device determines that the first data carried in the access request may have data that is to not be transmitted to the target server, and needs to be authenticated. When the access request does not have the corresponding data authentication rule, the access device determines that all the first data carried in the access request may be transmitted to the target server, and the data in the access request does not need to be authenticated using the data authentication server.

303: The data authentication server searches for the configuration information based on the user identifier in the access request and the mapping relationship.

In this example, after the access device transmits the access request to the data authentication server, the data authentication server can obtain the access request. In this way, after receiving the access request, the data authentication server processes the access request, so as to extract the user identifier and the first data from the access request. The data authentication server can learn a related configuration situation of the user identifier using the user identifier and the known mapping relationship. Therefore, after obtaining the user identifier, the data authentication server can further search for the corresponding configuration information based on the user identifier and the mapping relationship.

For the configuration information described herein, reference may be made to the configuration information described in the forging operation 301 for understanding, and details are not described herein again.

304: The data authentication server performs authentication processing on the first data based on the configuration information to obtain an authentication result.

In this example, after finding the configuration information, the data authentication server further needs to perform authentication processing on the first data based on the configuration information, so as to obtain the authentication result. A processing strategy for the first data, for example, interception processing or transmission processing, can be learned according to the authentication result. The described transmission processing may be understood as that the access device continues to transmit the first data to the target server. The described interception processing may be understood as intercepting the first data at the access device, and the access device does not forward the first data to the target server, thereby preventing the first data from being transmitted to the target server.

For example, how the data authentication server performs the authentication processing on the first data may be understood by referring to the following manner, i.e., the data authentication server first determines the configuration status of the configuration information, the configuration status including the first setting status and the second setting status. For example, the data authentication server may search for an option setting related to the type of the first data in the configuration information. For example, if the option setting is “checked”, the configuration status corresponding to the type of the first data is the second setting status. Otherwise, if the option setting is “not checked”, the configuration status corresponding to the type of the first data is the first setting status. For the first setting status and the second setting status described herein, reference may be made to the content described in the forging operation 301 for understanding, and details are not described herein again. After determining the configuration status corresponding to the type of the first data from the configuration information, the data authentication server performs the authentication processing on the first data based on the configuration status, so as to obtain the authentication result.

For example, the data authentication server may determine that the authentication result for the first data is the first status code when the configuration status is the first setting status. The described first status code is configured to represent a response code when first data needs to be intercepted, and for example, includes, but is not limited to, a response code 401 in the HTTP. In some examples, after determining that the authentication result for the first data includes the first status code, the data authentication server may further add the first response information corresponding to the first status code to the authentication result, so that in a subsequent process of transmitting the authentication result to the access device, the first response information corresponding to the first status code can be transmitted to the access device. After the described first response information is forwarded by the access device to the terminal device, the terminal device can learn that the access request has been responded.

For example, FIG. 6 shows an exemplary schematic diagram when data needs to be intercepted according to the present disclosure. As shown in FIG. 6, for the access request “X-GAAP-Request-Host:abcd.cn;X-GAAP-Request-Uri:/test/post_request_auth_failed_with_json_response”, an authentication result that may be determined by the data authentication server includes a first status code, for example, “HTTP/1.1 401 Unauthorized”. Correspondingly, the corresponding first response information is “X-GAAP-Filter-Auth-Http-Status-code:200;X-GAAP-Filter-Auth-Http-Content-type:application/json;X-GAAP-Filter-Auth-Http-X-abc-Environment:test;X-GAAP-Filter-Auth-Http-Body:eyJjb2Rlljox...”.

Alternatively, when determining that the configuration status is the second setting status, the data authentication server may determine that the authentication result is the second status code based on the data authentication rule. The described second status code is configured to represent the response code when the first data does not need to be intercepted, and for example, includes, but is not limited to, the response code 200 mentioned above.

305: The data authentication server transmits the authentication result to the access device.

In this example, after determining the authentication result, the data authentication server may transmit the authentication result to the access device.

306: The access device performs, based on the authentication result, interception processing or transmission processing on the first data.

In this example, after the data authentication server transmits the authentication result to the access device, the access device can obtain the authentication result. In this way, the access device may perform, based on the authentication result, the interception processing or the transmission processing on the first data. For example, because the authentication result includes the first status code or the second status code, and the first status code can indicate that the first data needs to be intercepted, the second status code indicates that the first data does not need to be intercepted. Therefore, after obtaining the authentication result, the access device determines whether to perform the interception processing or the transmission processing on the first data by determining whether the authentication result is the first status code or the second status code. For details, reference may be made to the following content of Case 1 and Case 2 for understanding.

Case 1: A case in which the authentication result includes the first status code.

For example, when determining that the authentication result includes the first status code, the access device performs, based on the first status code, the interception processing on the first data. The interception processing includes not forwarding the first data, for example, not forwarding the first data to a subsequent forwarding device of a link in order to avoid forwarding the first data to the target server using the subsequent forwarding device.

In some embodiments, when the authentication result includes the first status code, the authentication result further includes the first response information corresponding to the first status code. After the data authentication server transmits the authentication result to the access device, the access device may further extract the first response information from the authentication result, and transmit the first response information to the terminal device after performing, based on the first status code, the interception processing on the first data, so as to notify, using the first response information, the terminal device that the access request has been responded. Therefore, the terminal device does not need to perceive that the access request has been intercepted by the access device.

Case 2: A case in which the authentication result includes the second status code.

For example, if determining that the authentication result includes the second status code, the access device may further transmit the first data to the target server through the cloud-based acceleration channel based on the second status code. For example, the access device may forward the first data to the forwarding device through the cloud-based acceleration channel, and the forwarding device continues to transmit the first data to the target server.

As can be seen, different authentication results are distinguished by different status codes, so that the access device may accurately determine, based on the status code, whether to intercept the first data in the access request, thereby avoiding additional parsing and processing. Also, after an agreement is made using a specific response code, for the access device, the status code can be identified more conveniently, thereby improving response efficiency.

In this way, after receiving the first data transmitted by the access device, the target server performs response processing on the first data to obtain the second data corresponding to the first data. In this way, the target server maps the second data to an access response message, so as to transmit the access response message to the access device using the forwarding device. Therefore, the access device may further receive the access response message transmitted by the target server after transmitting the first data to the target server based on the second status code through the cloud-based acceleration channel, and transmits the access response message to the terminal device, so that the terminal device can obtain the second data corresponding to the first data.

In addition to that the access device may perform targeted interception on the data in the access request when the terminal device accesses the target server, the access device may further accurately forward the second data to the terminal device when the target server returns the second data after processing the access request, thereby improving system completeness. In some other examples, in addition to Case 1 or Case 2 mentioned above, if the data authentication server cannot be normally accessed due to a case such as a device failure or a network connection failure occurring in the data authentication server, the access device still needs to feed back a response to the terminal device, so that the terminal device can learn that the access request fails. In this case, after detecting the data authentication rule, the access device may further obtain the second response information. A response situation when the access to the data authentication server fails for the access request can be indicated by the second response information. After obtaining the second response information, the access device further needs to transmit the second response information to the terminal device, so that the terminal device can retransmit the access request as instructed by the second response information.

In some other examples, if the access device does not detect the data authentication rule, the first data does not need to be intercepted. In this case, the access device directly forwards the access request to the forwarding device, so as to transmit the access request to the target server using the forwarding device. In this way, after responding to the access request, the target server sequentially transmits the response to the terminal device by the forwarding device and the access device.

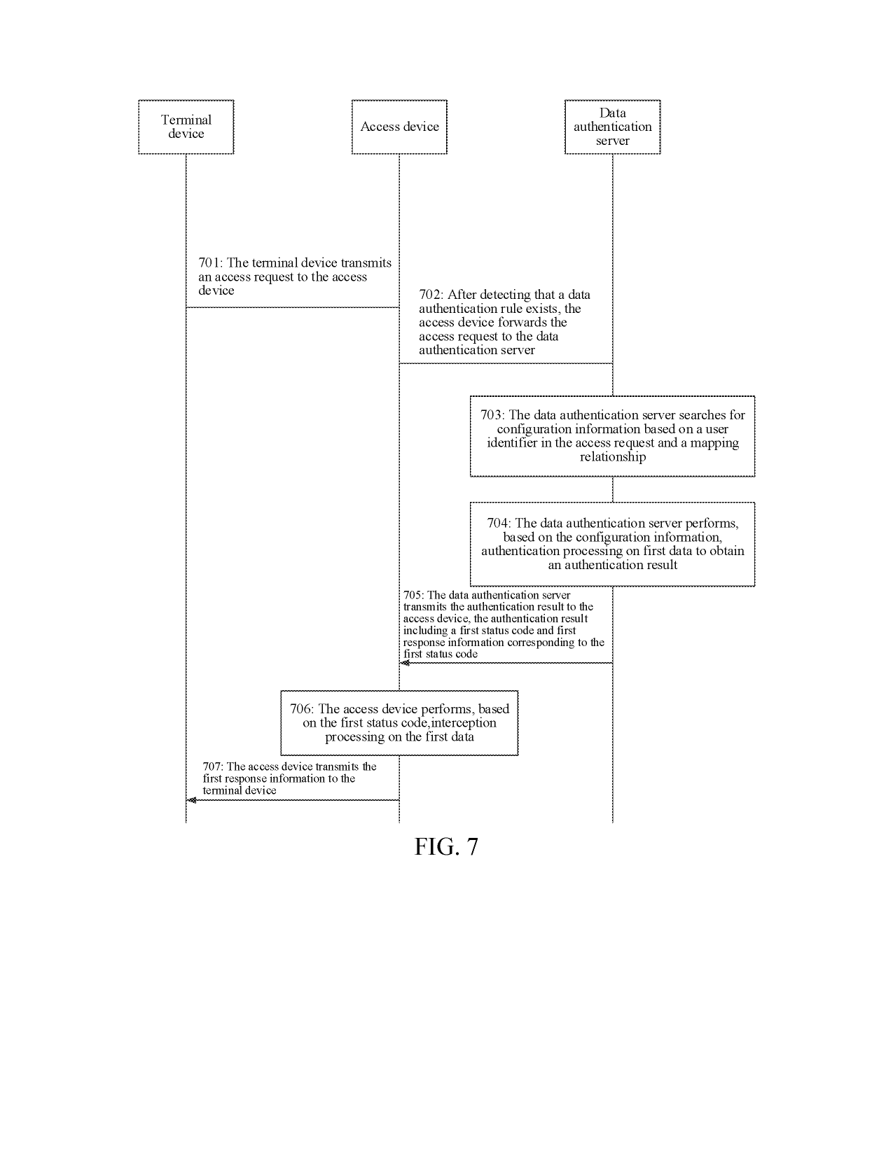

FIG. 7 shows another exemplary schematic flowchart of data processing according to the present disclosure. As shown in FIG. 7, this flow at least includes the following operations.

701: A terminal device transmits an access request to an access device, the access request including first data and a user identifier, the user identifier having a mapping relationship with configuration information, and the configuration information being configured to indicate whether different types of data are allowed to be transmitted to a target server.

702: After detecting that a data authentication rule exists, the access device forwards the access request to a data authentication server.

703: The data authentication server searches for the configuration information based on the user identifier in the access request and the mapping relationship.

704: The data authentication server performs authentication processing on the first data based on the configuration information to obtain an authentication result.

705: The data authentication server transmits the authentication result to the access device, the authentication result including a first status code and first response information corresponding to the first status code.

For operation 701 to operation 705 mentioned above, reference may be made to the content described in the foregoing operation 301 to operation 305 in FIG. 3 for understanding, and details are not described herein again.

706: The access device performs, based on the first status code, interception processing on the first data.

In this example, for the described first status code, reference may be made to the content described in the foregoing operation 304 in FIG. 3 for understanding, and details are not described herein again. After receiving the authentication result transmitted by the data authentication server and if determining that the authentication result is the first status code, the access device may perform, based on the first status code, the interception processing on the first data, so as to avoid that the first data is forwarded to the target server through a cloud-based acceleration channel, thereby ensuring data security.

707: The access device transmits the first response information to the terminal device.

In this example, since the first data has been subjected to the interception processing by the access device, a response still needs to be fed back to the terminal device, in order to ensure that the terminal device does not perceive that the access request corresponding to the first data is intercepted. For example, the data authentication server adds the first response information corresponding to the first status code to the authentication result, so as to transmit the authentication result to the access device. In this way, after receiving the authentication result, and after the interception processing of the first data according to the first status code, the access device feeds back the first response information to the terminal device.

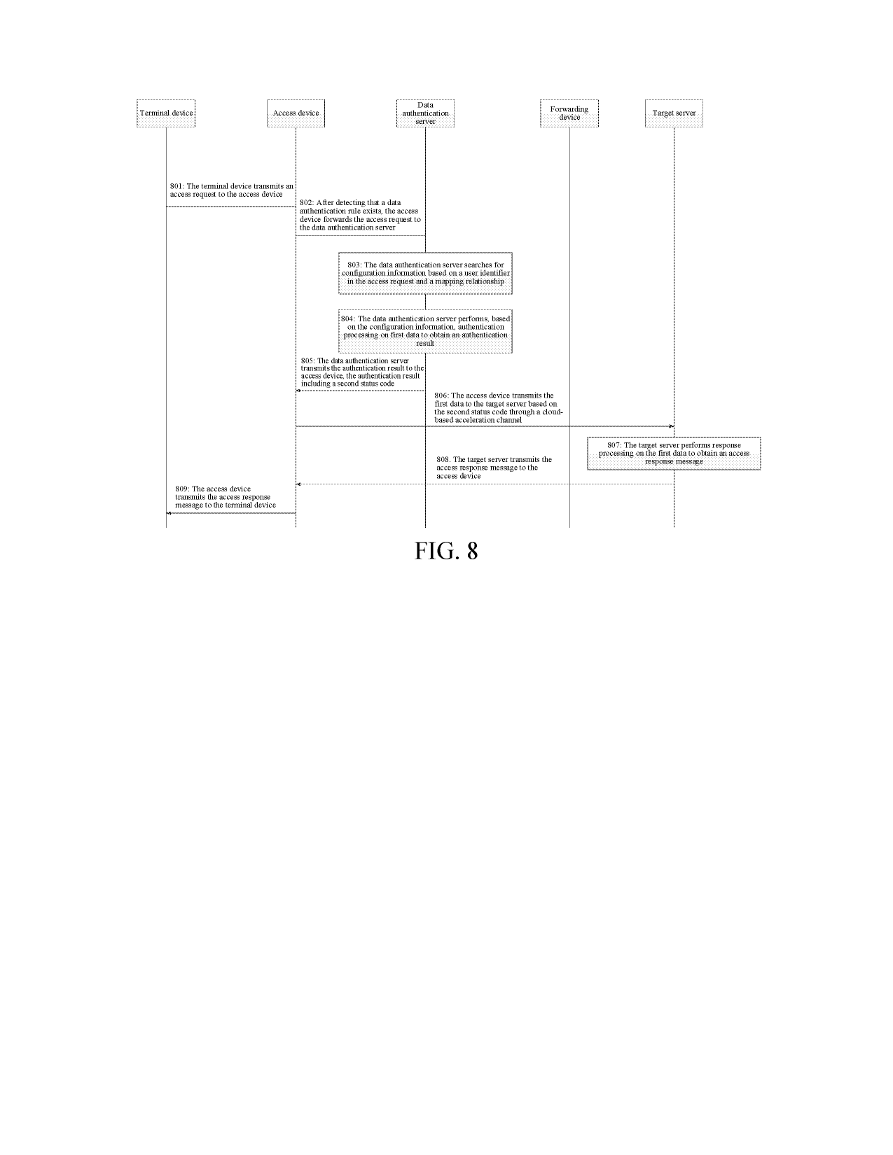

FIG. 7 describes an implementation process when data is intercepted from the perspective of an embodiment, and the following describes a process when data is not intercepted from the perspective of an embodiment. FIG. 8 shows another exemplary schematic flowchart of data processing according to the present disclosure. As shown in FIG. 8, this flow at least includes the following operations.

801: A terminal device transmits an access request to an access device, the access request including first data and a user identifier, the user identifier having a mapping relationship with configuration information, and the configuration information being configured for indicating whether different types of data are allowed to be transmitted to a target server.

802: After detecting that a data authentication rule exists, the access device forwards the access request to a data authentication server.

803: The data authentication server searches for the configuration information based on the user identifier in the access request and the mapping relationship.

804: The data authentication server performs authentication processing on the first data based on the configuration information to obtain an authentication result.

805: The data authentication server transmits the authentication result to the access device, the authentication result including a second status code.

For operation 801 to operation 805 mentioned above, reference may be made to the content described in the foregoing operation 301 to operation 305 in FIG. 3 for understanding, and details are not described herein again.

806: The access device transmits the first data to the target server based on the second status code through a cloud-based acceleration channel.

In this example, for the described second status code, reference may be made to the content described in the foregoing operation 304 in FIG. 3 for understanding, and details are not described herein again. After receiving the authentication result transmitted by the data authentication server and if determining that the authentication result is the second status code, the access device may determine that the first data does not need to be intercepted. In this case, the access device may transmit the first data to the target server through the cloud-based acceleration channel. For example, the access device forwards the first data to the forwarding device, and then the forwarding device forwards the first data to the target server.

807: The target server performs response processing on the first data to obtain an access response message.

In this example, after receiving the first data transmitted by the access device, the target server performs the response processing on the first data to obtain the second data corresponding to the first data. In this way, the target server maps the second data to an access response message, so as to transmit the access response message to the access device using the forwarding device.

808. The target server transmits the access response message to the access device.

809: The access device transmits the access response message to the terminal device.

In this example, after determining the access response message, the target server may transmit the access response message to the access device using the forwarding device, so that the access device transmits the access message to the terminal device.

In the embodiment of the present disclosure, before the access request, the first data, and the like that are transmitted by the terminal device are transmitted to the target server, the access device first forwards the access request and the data authentication rule to the data authentication server, and further determines, in advance using the authentication result fed back by the data authentication server after the data authentication server performs the authentication processing on the configuration information, whether to intercept the first data or continue to transmit the first data. In other words, in the present disclosure, a data interception function is implemented using the access device and the data authentication server. Before the first data is transmitted to the target server, whether to intercept the first data can be determined in advance at the access device based on the authentication result fed back by the data authentication server, without upgrading and reforming the terminal device. This not only avoids data leakage and improves data security, but also reduces difficulty and costs of reforming and upgrading.

The foregoing mainly describes solutions provided in the embodiments of the present disclosure from a method perspective. To implement the above functions, a corresponding hardware structure and/or software module configured to perform each function are/is included. A person of skills in the art is to be easily aware that, in combination with example modules and algorithm operations described in embodiments disclosed in the present disclosure, the present disclosure may be implemented by hardware or a combination of hardware and computer software. Whether a function is executed in a mode of hardware or hardware driven by computer software depends on particular applications and design constraint conditions of the technical solutions. A person skilled in the art may use different methods to implement the described functions for each particular application, but such implementation is to not be considered beyond the scope of the present disclosure.

In the embodiments of the present disclosure, division into functional modules of the apparatus may be performed according to the foregoing method examples. For example, the division into the functional modules may be based on corresponding functions, or two or more functions may be integrated into one processing module. The integrated module may be implemented in a form of hardware, or may be implemented in a form of a software functional module. Module division in the embodiments of the present disclosure is an example and is merely logical function division, and there may be another division manner in actual implementation.

In the embodiments of the present disclosure, the term “module” or “unit” refers to a computer program with a preset function or a part of the computer program and works, together with other related parts, to implement a preset target, and may be completely or partially implemented by using software, hardware (for example, a processing circuit or a memory) or a combination thereof. Similarly, one processor (or a plurality of processors or memories) may be configured to implement one or more modules or units. In addition, each module or unit may be a part of an overall module or unit including a function of the module or unit.

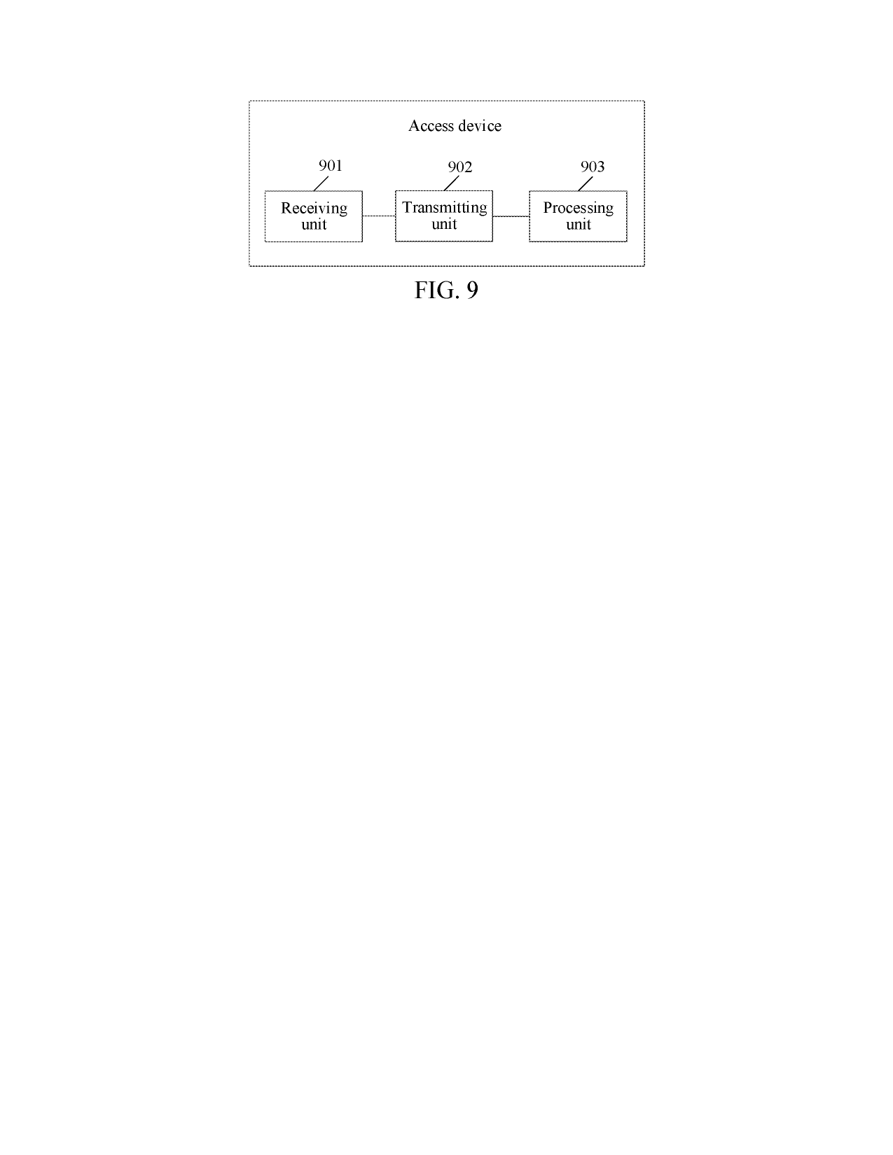

The following describes the access device in the embodiment of the present disclosure in detail. FIG. 9 is an exemplary schematic diagram of functional modules of an access device according to an embodiment of the present disclosure. As shown in FIG. 9, the access device may include a receiving unit 901, a transmitting unit 902, and a processing unit 903.

The receiving unit 901 is configured to receive an access request transmitted by a terminal device, the access request including first data and a user identifier, the user identifier having a mapping relationship with configuration information, and the configuration information being configured to indicate whether different types of data are allowed to be transmitted to a target server.

The transmitting unit 902 is configured to forward the access request to a data authentication server after detecting that a data authentication rule exists, so that the data authentication server, after finding the configuration information based on the user identifier and the mapping relationship, performs authentication processing on the first data based on the configuration information to obtain an authentication result.

The processing unit 903 is configured to perform, based on the authentication result, interception processing or transmission processing on the first data after receiving the authentication result transmitted by the data authentication server.

In some implementations, the processing unit 903 is configured to perform the interception processing on the first data based on a first status code when the authentication result includes the first status code, so as to not transmit the first data to the target server, the first status code being configured to represent a response code when the first data needs to be intercepted.

In some other implementations, the first status code is a response code 401.

In some other implementations, the authentication result further includes first response information corresponding to the first status code. The transmitting unit 902 is further configured to transmit the first response information to the terminal device after performing, based on the first status code, the interception processing on the first data, the first response information being configured for the terminal device to learn that the access request has been responded.

In some other implementations, the processing unit 903 is configured to transmit the first data to the target server based on the second status code through a cloud-based acceleration channel when the authentication result includes a second status code, the second status code being configured to represent a response code when the first data does not need to be intercepted.

In some other implementations, the second status code is a response code 200.

In some other implementations, the receiving unit 901 is further configured to receive an access response message transmitted by the target server after transmitting the first data to the target server based on the second status code through the cloud-based acceleration channel, the access response message including second data, and the second data being data obtained by the target server in response to the first data. The transmitting unit 902 is configured to forward the access response message to the terminal device.

In some other implementations, the receiving unit 901 is further configured to obtain second response information after detecting that the data authentication rule exists, the second response information being configured to indicate a response situation when access to the data authentication server fails for the access request. The transmitting unit 902 is configured to transmit the second response information to the terminal device, the second response information being configured to instruct the terminal device to retransmit the access request.

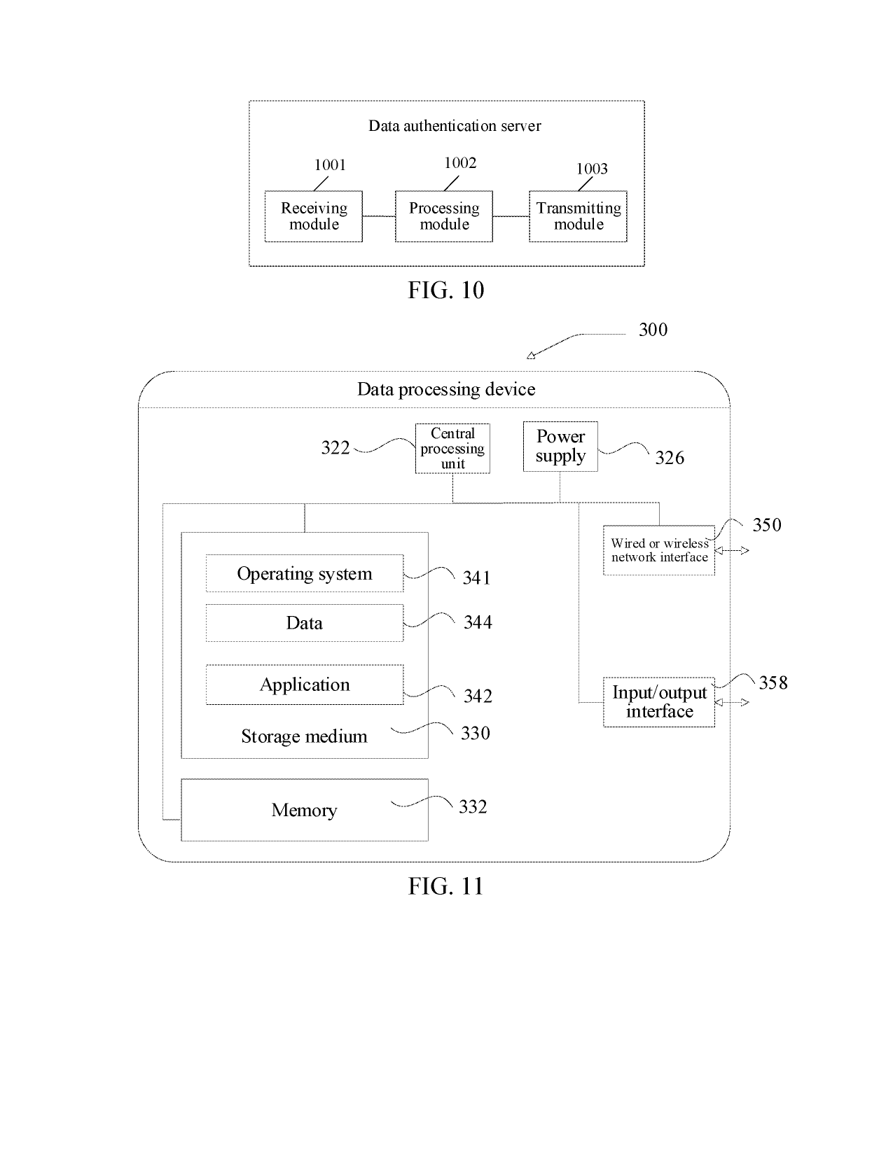

The access device in the embodiment of the present disclosure is described above from the perspective of a modular functional entity, and the data authentication server in the embodiment of the present disclosure is described below from the perspective of the modular functional entity. FIG. 10 is an exemplary schematic diagram of functional modules of a data authentication server according to an embodiment of the present disclosure. As shown in FIG. 10, the data authentication server may include a receiving module 1001, a processing module 1002, and a transmitting module 1003.

The receiving module 1001 is configured to receive an access request transmitted by an access device, the access request including first data and a user identifier, the user identifier having a mapping relationship with configuration information, and the configuration information being configured to indicate whether different types of data are allowed to be transmitted to a target server.

The processing module 1002 is configured to search for the configuration information based on the user identifier in the access request and the mapping relationship. The processing module is configured to perform authentication processing on the first data based on the configuration information to obtain an authentication result.

The transmitting module 1003 is configured to transmit the authentication result to the access device, the authentication result being configured for the access device to perform interception processing or transmission processing on the first data.

In some implementations, the processing module 1002 is configured to: determine a configuration status of the configuration information, the configuration status including a first setting status or a second setting status for a first data type of the first data, the first setting status being configured to represent that data of the first data type is not allowed to be transmitted to the target server, and the second setting status being configured for representing that the data of the first data type is allowed to be transmitted to the target server; and perform authentication processing on the first data based on the configuration status to obtain the authentication result.

In some other implementations, the processing module 1002 is configured to determine that the authentication result is a first status code when the configuration status is the first setting status, the first status code configured to represent a response code when the first data needs to be intercepted.

In some other implementations, the authentication result further includes first response information corresponding to the first status code, so that the access device forwards the first response information to a terminal device, and the first response information is configured for the terminal device to learn that the access request has been responded.

In some other implementations, the processing module 1002 is configured to: determine that the authentication result is a second status code when the configuration status is the second setting status, the second status code being configured to represent a response code when the first data does not need to be intercepted.

The access device and the data authentication server in the embodiment of the present disclosure are described above from the perspective of modular functional entities, and a data processing device in the embodiment of the present disclosure is described below from the perspective of hardware processing. FIG. 11 is a schematic diagram of a data processing device according to an embodiment of the present disclosure. The data processing device may vary greatly due to different configurations or performance, for example, including, but not limited to, the access device shown in FIG. 9 and the data authentication server shown in FIG. 10.

As shown in FIG. 11, the data processing device 300 may vary greatly due to different configurations or performance, and may include one or more central processing units (CPU) 322 (for example, one or more processors) and a memory 332, and one or more storage media 330 (for example, one or more mass storage devices) that store application programs 342 or data 344. The memory 332 and the storage medium 330 may be transient or persistent storages. The program stored in the storage medium 330 may include one or more modules (not shown in the figure), and each module may include a series of instructions for the data processing device. Further, the central processing unit 322 may be configured to communicate with the storage medium 330, and execute, on the data processing device 300, the series of instruction operations in the storage medium 330. For example, the central processing unit 322 is configured to execute the application program 342 stored in the storage medium 330, so as to implement the data processing method provided in the foregoing embodiment of the present disclosure.

The data processing device 300 may further include one or more power supplies 326, one or more wired or wireless network interfaces 350, one or more input/output interfaces 358, and/or one or more operating systems 341, such as Windows Server^{TM}, Mac OS X^{TM}, Unix^{TM}, Linux^{TM}, and FreeBSD^{TM}.

For example, the central processing unit 322 in FIG. 11 may invoke computer-executable instructions stored in the memory 332 to cause the data processing device to perform the methods in the method embodiments corresponding to FIG. 3 to FIG. 8.

Functions/implementation processes of the processing unit 903 in FIG. 9 and the processing module 1002 in FIG. 10 may be implemented by the central processing unit 322 in FIG. 11 by invoking the computer-executable instructions stored in the memory 332. Functions/implementation processes of the receiving unit 901 and the transmitting unit 902 in FIG. 9, and the receiving module 1001 and the transmitting module 1003 in FIG. 10 may be implemented using the input/output interface 358 in FIG. 11.

Operations performed by the data processing device in the foregoing embodiments may be based on a structure of the data processing device that is shown in FIG. 11.

In addition, an embodiment of the present disclosure further provides a storage medium, configured to store a computer program, the computer program being configured to perform the method provided in the foregoing embodiments.

An embodiment of the present disclosure further provides a computer program product including a computer program, the computer program, when run on a computer, causing the computer to perform the method provided in the foregoing embodiments.

All or some of the above embodiments may be implemented by means of software, hardware, firmware or any combination thereof. When the software is used for implementation, all or some of the embodiments may be implemented completely or partially in a form of a computer program product.

A person skilled in the art can clearly understand that for convenience and conciseness of description, for specific working processes of the foregoing systems, apparatuses and units, reference may be made to the corresponding processes in the foregoing method embodiments, and details are not described herein again.

In the several embodiments provided in the present disclosure, the disclosed system, apparatus, and method may be implemented in other manners. For example, the described apparatus embodiments above are merely schematic. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate components may or may not be physically separated, and components displayed as units may or may not be physical units, i.e., may be located in one position, or may be distributed on a plurality of network units. Some or all of the units may be selected according to actual needs to achieve the objectives of the solutions of the embodiments.

In addition, functional units in the embodiments of the present disclosure may be integrated into one processing unit, or each of the units may exist alone physically, or two or more units may be integrated into one unit. The above integrated unit may be implemented in a form of hardware, or may be implemented in a form of a software functional unit.

When the integrated unit is implemented in the form of the software functional unit and sold or used as an independent product, the integrated unit may be stored in a computer-readable storage medium. Based on such an understanding, the technical solutions of the present disclosure essentially, or the part contributing to the related art, or all or some of the technical solutions may be implemented in a form of a software product. The computer software product is stored in a storage medium and includes several instructions for instructing a computer device (which may be a personal computer, a server, a network device, or the like) to perform all or some of the operations of the methods described in the embodiments of the present disclosure. The foregoing storage medium includes: any medium that can store program code, such as a USB flash drive, a removable hard disk, a read-only memory (ROM), a random access memory (RAM), a magnetic disk, or an optical disc.

The computer program product includes one or more computer instructions. When the computer-executable instructions are loaded and executed on a computer, the procedures or functions according to the embodiments of the present disclosure are all or partially generated. The computer may be a general-purpose computer, a dedicated computer, a computer network, or other programmable apparatuses. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid state drive (SSD)), or the like.

The foregoing embodiments are merely used for describing the technical solutions of the present disclosure, and do not limit the technical solutions of the present disclosure. Although the present disclosure is described in detail with reference to the foregoing embodiments, a person of ordinary skills in the art is to understand that, the technical solutions described in the foregoing embodiments may still be modified, or some of technical features thereof may still be equivalently replaced; and these modifications or replacements do not make essence of a corresponding technical solution depart from the spirit and scope of the technical solutions of the embodiments of the present disclosure.

What is claimed is:

1. A data processing method, applied to an access device, the method comprising:
receiving an access request transmitted by a terminal device, the access request comprising first data and a user identifier, the user identifier having a mapping relationship with configuration information, and the configuration information being configured to indicate whether different types of data are allowed to be transmitted to a target server;
forwarding the access request to a data authentication server after detecting that the access request has a corresponding data authentication rule, so that the data authentication server, after finding the configuration information based on the user identifier and the mapping relationship, performs authentication processing on the first data based on the configuration information to obtain an authentication result; and
performing, based on the authentication result, interception processing or transmission processing on the first data after receiving the authentication result transmitted by the data authentication server.

2. The method according to claim 1, wherein the performing, based on the authentication result, interception processing or transmission processing on the first data comprises:
performing interception processing on the first data based on a first status code when the authentication result comprises the first status code, so as to not transmit the first data to the target server, the first status code being configured for representing a response code when the first data needs to be intercepted.

3. The method according to claim 2, wherein the first status code is a response code 401.

4. The method according to claim 2, wherein the authentication result further comprises first response information corresponding to the first status code; and after the performing, based on the first status code, interception processing on the first data, the method further comprises:
transmitting the first response information to the terminal device, the first response information being configured for the terminal device to learn that the access request has been responded.

5. The method according to claim 1, wherein the performing, based on the authentication result, interception processing or transmission processing on the first data comprises:
transmitting the first data to the target server based on a second status code through a cloud-based acceleration channel when the authentication result comprises the second status code, the second status code being configured to represent a response code when the first data does not need to be intercepted.

6. The method according to claim 5, wherein the second status code is a response code 200.

7. The method according to claim 5, wherein after the transmitting the first data to the target server based on a second status code through a cloud-based acceleration channel, the method further comprises:
receiving an access response message transmitted by the target server, the access response message comprising second data, and the second data being data obtained by the target server in response to the first data; and
forwarding the access response message to the terminal device.

8. The method according to claim 1, wherein after the detecting that the access request has a corresponding data authentication rule, the method further comprises:
obtaining second response information, the second response information being configured for indicating a response situation when access to the data authentication server fails for the access request; and
transmitting the second response information to the terminal device, the second response information being configured for instructing the terminal device to retransmit the access request.

9. An access device, comprising:
at least one memory configured to store program code; and
at least one processor configured to read the program code and operate as instructed by the program code, the program code comprising:
a first receiving code configured to cause the at least one of the at least one processor to receive an access request transmitted by a terminal device, the access request comprising first data and a user identifier, the user identifier having a mapping relationship with configuration information, and the configuration information being configured for indicating whether different types of data are allowed to be transmitted to a target server;
a first transmitting code configured to cause the at least one of the at least one processor to forward the access request to a data authentication server after detecting that the access request has a corresponding data authentication rule, so that the data authentication server, after finding the configuration information based on the user identifier and the mapping relationship, performs authentication processing on the first data based on the configuration information to obtain an authentication result; and
a processing code configured to cause the at least one of the at least one processor to perform, based on the authentication result, interception processing or transmission processing on the first data after receiving the authentication result transmitted by the data authentication server.

10. The access device according to claim 9, wherein the processing code further comprises a performing code configured to cause the at least one of the at least one processor to perform interception processing on the first data based on a first status code when the authentication result comprises the first status code, so as to not transmit the first data to the target server, the first status code being configured to represent a response code when the first data needs to be intercepted.

11. The access device according to claim 10, wherein the first status code is a response code 401.

12. The access device according to claim 10, wherein the authentication result further comprises first response information corresponding to the first status code, and the performing code, based on the first status code, further comprises a second transmitting code configured to cause the at least one of the at least one processor to transmit the first response information to the terminal device, the first response information being configured for the terminal device to learn that the access request has been responded.

13. The access device according to claim 10, wherein the processing code further comprises a third transmitting code configured to cause the at least one of the at least one processor to transmit the first data to the target server based on a second status code through a cloud-based acceleration channel when the authentication result comprises the second status code, the second status code being configured to represent a response code when the first data does not need to be intercepted.

14. The access device according to claim 13, wherein the second status code is a response code 200.

15. The access device according to claim 13, wherein the third transmitting code further comprises:
a second receiving code configured to cause the at least one of the at least one processor to receive an access response message transmitted by the target server, the access response message comprising second data, and the second data being data obtained by the target server in response to the first data; and
a forwarding code configured to cause the at least one of the at least one processor to forward the access response message to the terminal device.

16. The access device according to claim 9, wherein the first transmitting code further comprises:
an obtaining code configured to cause the at least one of the at least one processor to obtain second response information, the second response information being configured for indicating a response situation when access to the data authentication server fails for the access request; and
a fourth transmitting code configured to cause the at least one of the at least one processor to transmit the second response information to the terminal device, the second response information being configured for instructing the terminal device to retransmit the access request.

17. A non-transitory computer-readable storage medium, storing computer code which, when executed by at least one processor, causes the at least one processor to at least:
receive an access request transmitted by a terminal device, the access request comprising first data and a user identifier, the user identifier having a mapping relationship with configuration information, and the configuration information being configured to indicate whether different types of data are allowed to be transmitted to a target server;
forward the access request to a data authentication server after detecting that the access request has a corresponding data authentication rule, so that the data authentication server, after finding the configuration information based on the user identifier and the mapping relationship, performs authentication processing on the first data based on the configuration information to obtain an authentication result; and
perform, based on the authentication result, interception processing or transmission processing on the first data after receiving the authentication result transmitted by the data authentication server.

18. The non-transitory computer-readable storage medium according to claim 17, wherein the computer code which, when executed by at least one processor, further causes the at least one processor to at least:
perform interception processing on the first data based on a first status code when the authentication result comprises the first status code, so as to not transmit the first data to the target server, the first status code being configured for representing a response code when the first data needs to be intercepted.

19. The non-transitory computer-readable storage medium according to claim 18, wherein the first status code is a response code 401.

20. The non-transitory computer-readable storage medium according to claim 17, wherein the authentication result further comprises first response information corresponding to the first status code, and wherein the computer code which, when executed by at least one processor, further causes the at least one processor to at least:
transmit the first response information to the terminal device, the first response information being configured for the terminal device to learn that the access request has been responded.
